(19) United States
(12) Patent Application Publication
(10) Pub. No.: US 2026/0244329 A1
(43) Pub. Date: Aug. 20, 2026

(54) Method and Device for Configuring a Panoramic HUD Display in a Vehicle

(71) Applicant: Bayerische Motoren Werke Aktiengesellschaft, Muenchen (DE)

(72) Inventor: Julian EICHHORN, Muenchen (DE)

(21) Appl. No.: 19/543,035

(22) Filed: Feb. 18, 2026

(30) Foreign Application Priority Data
Feb. 19, 2025 (DE) 10 2025 106 219.6

(51) Int. Cl. G06F 3/04847; B60K 35/10; B60K 35/233; B60K 35/28; B60K 35/81; G06F 3/0488; G06F 3/0486

(52) U.S. Cl. CPC G06F 3/04847; B60K 35/10; B60K 35/233; B60K 35/28; B60K 35/81; G06F 3/0488; B60K 2360/1438; B60K 2360/1468; B60K 2360/164; B60K 2360/166; B60K 2360/18; B60K 2360/23; B60K 2360/592; G06F 3/0486

(57) ABSTRACT

A display system for a vehicle includes a PHUD display having a display device. The displayed display image of the display device is perceptible by a user on a display surface by reflection. An arrangement and a selection of display-objects are displayable in respective display areas on the display surface in accordance with a configuration setting. The system also includes an operating device having a display unit and an input unit for performing operating inputs. The system also includes a control unit, designed to display display-object symbols on the display unit and to assign them to a display area of the display surface by operating inputs using the input unit or remove them therefrom in order to define a configuration setting.

### CROSS REFERENCE TO RELATED APPLICATION

This application claims priority under 35 U.S.C. §119 from German Patent Application No. 10 2025 106 219.6, filed February 19, 2025, the entire disclosure of which is herein expressly incorporated by reference.

### BACKGROUND AND SUMMARY

The invention relates to a head-up display (HUD) for a motor vehicle or another land, air, or water vehicle. The HUD comprises an imaging display surface, which is arranged in an upper side of an instrument panel of the vehicle and extends along a windshield in the transverse direction of the vehicle so that a vehicle occupant, such as a driver or front passenger, when looking at a lower section of a windshield, sees the display surface reflected therein (virtual display image). The invention is also directed to a vehicle equipped therewith.

Using an HUD of this type, which is also called a panoramic HUD (PHUD), it is desired for a continuous virtual image having entertainment, communication, or navigation content or vehicle-relevant or driver-relevant image content to be displayed to a driver or front passenger of the vehicle, which can extend in particular like a panoramic image as much as possible over the entire width of the windshield, i.e. in the transverse direction of the vehicle. The imaging display surface accordingly has to extend along the windshield for this purpose.

The PHUD enables different graphic display objects to be displayed, which are displayed in display areas arranged adjacent to one another over the width of the PHUD display. The arrangement of the individual items of information and display objects has been fixed up to this point and allows few adjustments with respect to an individualization of the appearance, i.e. the arrangement and selection of the display objects over the width of the PHUD display.

It is an object of the present invention to provide an improved display system having a PHUD display, which enables a configuration of the display objects over the width of the PHUD display in an individual manner.

At least this object is achieved by the display system having a PHUD display and by the method for configuring a PHUD display described herein.

According to at least one embodiment, a display system for a vehicle is provided, comprising:
- A PHUD having a display device, the displayed display image of which is perceptible by a user due to reflection on a display surface, wherein an arrangement and a selection of display objects are displayable in respective display areas on the display surface in accordance with a configuration setting;
- An operating device having a display unit and an input unit for performing operating inputs;
- A control unit, which is designed to display display object symbols on the display unit and to assign them to a display area of the display surface or remove them therefrom due to operating inputs using the input unit in order to define a configuration setting.

It can be provided that the operating device is designed, in a configuration mode, by virtual displacement of display object symbols displayed on the display unit, to assign display objects assigned to those display object symbols to display areas of the display surface of the PHUD for output or display there.

Display objects can be, for example, text, symbol, or graphic representations, which are outputs of function implemented in the vehicle. The display objects can thus comprise:
- representations of vehicle-relevant information, such as a speed specification, an engine temperature specification, and the like,
- representations of driver-relevant specifications, such as a fatigue level and the like,
- representations of an output of an entertainment function, such as a display of the title and album cover of a music track being played, a display of the name and logo of a radio broadcaster, a volume indication, and the like, a video representation of a film, an image representation,
- representations of a navigation function, such as directional arrows, lane indicators, map representations, input masks for destination inputs, and the like,
- representations of the output of a communication function, such as a call list, short messages, a symbol for a connection to a mobile device with corresponding signal strength, the battery status of the mobile device, and the like, and
- representations of the output of third-party functions or third-party apps executed in the vehicle system, such as weather information, social media functions, smart home functions, and the like, and
- representations of the display screen content of a mobile device, so that the display screen content of the mobile device is reflected or transferred onto the display area of the display object.

The display objects can be provided in the form of so-called widgets, each of which defines a display area in which the relevant display object is displayed or output as an output of a vehicle function.

The width of the perceptible display surface is essentially oriented to the width of the windshield and is in particular at least 80% of the width of the windshield.

A corresponding display object for output or display there can be assigned to areas of the display surface of the PHUD display by the operating device in a configuration mode. The arrangement, the selection, and the order of the display objects displayed on the display surface of the PHUD display can thus be individually configured.

Display objects which are not permitted to be displayed during driving operation, such as video displays and the like, can be hidden or dimmed during driving operation so that they do not distract the driver from driving the motor vehicle.

The operating device can comprise a touch screen having a combined display unit and input unit.

It can be provided that the control unit is designed to define or select the configuration setting by the touchscreen operating gestures “tapping”, “dragging” and “dropping”, wherein display object symbols are displaceable between a display object pool having a plurality of selectable display object symbols and a configuration bar, wherein the arrangement of the display object symbols in the configuration bar indicates the arrangement, position, and selection of the display objects on the display surface.

The operating device can comprise at least one input unit and one display unit (display screen) and can comprise, for example, a touchscreen having a combined display unit and input unit (touch functionality) in the center console or as part of a vehicle assistance system.

In the configuration mode, in a configuration bar, a miniature representation of display areas of the display surface arranged adjacent to one another can be represented in symbolized form, for example as an empty frame or a symbol which identifies the display object assigned to the display area.

A plurality of display object symbols, each of which represents a display object to be displayed, is displayed in a display object pool displayed on the display unit, as an area of the display unit.

By operating the input unit, for example by tapping a display object symbol and by “dragging” the display object symbol into a corresponding display area of the configuration bar, display objects can be assigned to a specific display area of the display surface. The order of the display object symbols on the display unit corresponds here to the order and arrangement of the display objects on the display surface of the PHUD display.

A display object symbol can be removed from the display on the display surface in that it is selected from the configuration bar by tapping and is “dragged out” of the configuration bar and “dropped”, in particular onto a trashcan symbol. The “dragging” and “dropping” represent typical operating gestures for operating touchscreens, in which the finger is moved along the surface of the display screen surface or lifted. Alternatively, a “remove” symbol such as a “–” or “x” on the respective display object can be tapped in order to remove it from the configuration bar.

A display object can be displaced within the display surface in that the relevant display object symbol is tapped and held and dragged onto another area of the configuration bar. By removing the finger from the touchscreen, the corresponding display object symbol is “dropped” in the display area of the configuration bar which corresponds to the display area of the display surface of the PHUD display.

In order to depict the entire width of the display surface over the configuration bar, it can be selected in sections using the input unit, such as “left”, “middle”, and “right”, so that the display objects on the left side, in the middle, or on the right side of the display surface are displayed by the configuration bar and can be assigned to a corresponding display object.

Fewer sections are also conceivable, for example only “middle” and “right”, if the left section is not configurable, for example.

In the configuration mode, the assignments of the display objects to the display areas of the display surface can be made visible directly in the display surface as soon as the display object symbol has been assigned to the display area of the configuration bar.

It can be provided that the control unit is designed to display a selection element on the display unit, wherein the display objects are displayed according to a specific predefined configuration setting by operating the selection element.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic representation of a vehicle having a PHUD display and a touchscreen as an operating device; and

FIGS. 2a to 2c show representations of the operation of the operating device in a configuration mode for the PHUD display.

### DETAILED DESCRIPTION OF THE DRAWINGS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the

present invention, and is not intended to limit the broad aspects of the present invention to any embodiment illustrated.

Further in accordance with the practices of persons skilled in the art, aspects of one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

Additionally, reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases or in various

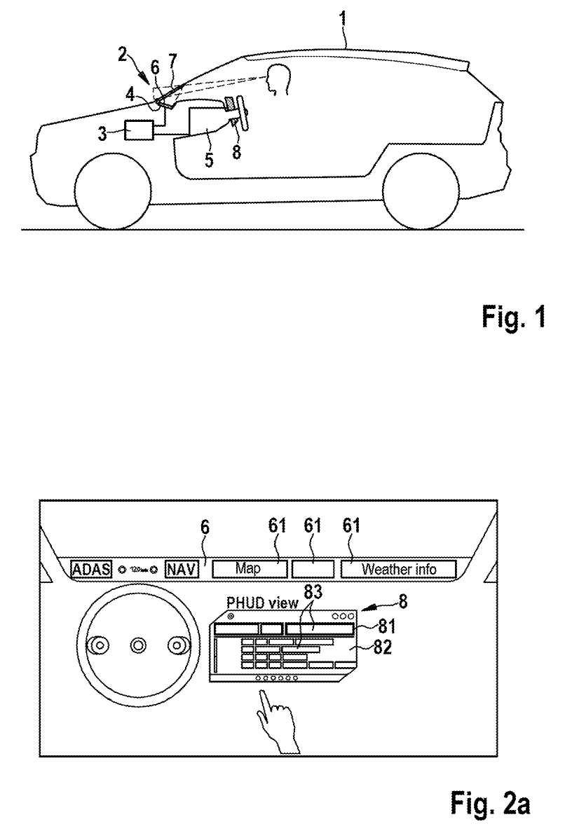

FIG. 1 schematically shows a motor vehicle 1 having a PHUD display 2, which can be operated via a control unit 3. The PHUD display 2 comprises a self-luminous display device 4, which is arranged flatly on the upper side of a dashboard 5. A display surface 6 of the PHUD display 4 has a width which essentially corresponds to the width of a windshield 9, but at least the width of 80% of the windshield 9.

The display device 4 is arranged close to the lower edge of the windshield 9, so that a display image can be perceived by a driver via a reflection on a lower area 7 (reflection surface) of the windshield 9. For this purpose, the lower area 7 of the windshield 9 is preferably designed as a black print area, i.e. as a nontransparent area.

Display objects can be displayed on the display surface of the display device, which are depicted as a text symbol or graphic representation and which are outputs of functions implemented in the vehicle. The following types of display objects can thus be displayed:
- representations of vehicle-relevant information, such as a speed specification, an engine temperature specification, and the like, - representations of driver-relevant specifications, such as a fatigue level and the like,
- representations of an output of an entertainment function, such as a display of the title of a music track being played, a display of the name of a radio broadcaster, a volume indication, and the like, a video representation of a film, an image representation,
- representations of a navigation function, such as directional arrows, map representations, input masks for destination inputs, and the like,
- representations of the output of a communication function, such as a call list, short messages, a symbol for a connection to a mobile device with corresponding signal strength, the battery status of the mobile device, and the like, and
- representations of the output of third-party functions or third-party apps executed in the vehicle system, such as weather information, social media functions, smart home functions, and the like, and
- representations of the display screen content of a mobile device, so that the display screen content of the mobile device is reflected or transferred onto the display area of the display object.

Furthermore, the control unit 3 is connected to an operating device 8, which can correspond, for example, to the touchscreen of a vehicle assistance system or is provided as a separate input option. For example, the operating device can also be provided by a mobile device, which is connected to the control unit 3 via a suitable interface.

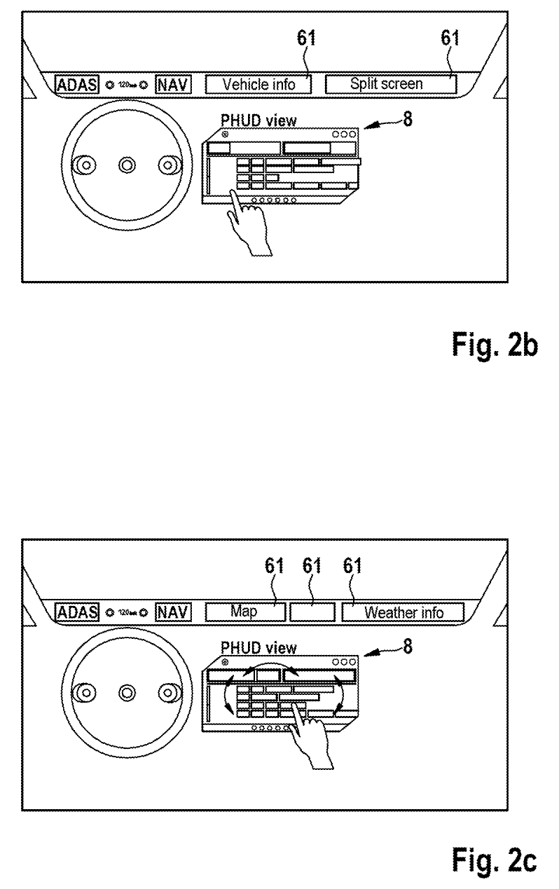

FIGS. 2a to 2c show possibilities for the configuration of the display of the display objects by the PHUD display 4. FIGS. 2a-2c show the view from the viewpoint of the driver in the interior of the motor vehicle 1. The display surface 6 of the PHUD display 2 can be seen together with displayed display objects 61 and the operating device 8 having the display unit, which shows a configuration surface and on which a configuration bar 81 and a display object pool 82 having multiple display object symbols 83 is displayed. The configuration bar 81 represents a miniaturized representation of the structure of the display surface 6 or the arrangement of the display objects on the display surface. The configuration surface can be operated in a configuration mode using the operating device 8 in order to individually position the display object symbols 83 in an area of the display surface by arrangement in the configuration bar 81.

The display surface 6 is divided into display areas 62, in which display objects, so-called widgets, can be assigned. The display objects 61 represent graphic outputs of vehicle functions.

As shown in FIG. 2b, the configuration bar indicates, for example using empty frames, positions of display areas of the display surfaces to which a display object or widget can be assigned.

Due to the large width of the display surface, each section of the display surface can be represented by the configuration bar, wherein it is possible to switch between the sections with the aid of a selection element 85.

As illustrated in FIG. 2c, by tapping a display object symbol from the display object pool and by dragging the display object symbol onto the corresponding area of the configuration bar, the display object assigned to the display object symbol can be positioned at the corresponding display area of the display surface, which corresponds to the area within the configuration bar.

Similarly, a display object symbol can be removed from the corresponding area of the configuration bar by tapping on it and dragging it out of the area of the configuration bar.

If the relevant display object symbol is dragged onto another area of the configuration bar, the corresponding areas of assigned display object symbols can be exchanged and therefore the display objects in the relevant assigned areas of the display surface can also be exchanged.

This is illustrated by the arrows shown in FIG. 2c.

After each assignment action and/or after ending the configuration mode, the corresponding display objects are displayed in the assigned areas of the display surface of the PHUD display.

Display objects which are not permitted to be displayed during driving operation are then dimmed or blackened, however, so that an impermissible distraction of the driver is avoided.

If the configuration of the PHUD display is completed, configuration settings can be stored individually for each user, so that upon recognition of a specific driver, the corresponding configuration settings can be used automatically for the display of the PHUD display. Furthermore, a selection element can be displayed, which enables changing between different configuration settings for the display surface by tapping.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference numerals

1 motor vehicle

2 PHUD display

3 control unit

4 display device

5 dashboard

6 display surface

9 windshield

7 lower area of the windshield

8 operating device

61 display objects

81 configuration bar

82 display object pool

83 display object symbols

62 display areas

What is claimed is:

1. A display system for a vehicle, comprising:
a PHUD display having a display device, wherein a displayed image of the display device is perceptible by a user on a display surface via reflection on a reflection surface, wherein an arrangement and a selection of display-objects are displayable in respective display areas via the reflection surface in accordance with a configuration setting;
an operating device having a display unit and an input unit for performing operating inputs;
a control unit designed to display display-object symbols on the display unit and to assign them to a display area of the display surface by operating inputs using the input unit or remove them therefrom in order to define a configuration setting.

2. The display system of claim 1, wherein the display-objects correspond to text, symbol, or graphic representations that are outputs of functions implemented in the vehicle and comprise representations of:
vehicle-relevant information,
driver-relevant specifications,
an output of an entertainment function,
a navigation function,
the output of a communication function,
the output of third-party functions or third-party apps executed in the vehicle system, and/or
the display screen content of a mobile device such that the display screen content of the mobile device is reflected or transferred onto the display area of the display surface.

3. The display system of claim 1, wherein the width of the perceptible display surface corresponds to at least 80% of the width of the windshield.

4. The display system of claim 1, wherein the operating device is configured to, in a configuration mode and by virtual displacement of display-object symbols displayed on the display unit, assign display-objects assigned to those display-object symbols to display areas of the display surface of the PHUD display for output or display there.

5. The display system of claim 1, wherein the control unit is configured to hide or dim, during driving operation, specific display-objects displayed on the display surface which are not permitted to be displayed during driving operation.

6. The display system of claim 1, wherein the operating device comprises a touchscreen having a combined display unit and input unit.

7. The display system of claim 6,
wherein the control unit is configured to define or select the configuration setting by touchscreen operating gestures comprising: tapping, dragging, and dropping,
wherein display-object symbols are displaceable between a display-object pool having a plurality of selectable display-object symbols and a configuration bar, and
wherein the arrangement of the display-object symbols in the configuration bar indicates the arrangement, position, and selection of the display objects on the display surface.

8. The display system of claim 6,
wherein the control unit is configured to display a selection element on the display unit, and
wherein the display-objects are displayed according to a specific predefined configuration setting by operating the selection element.
